(19) United States
(12) Patent Application Publication
(10) Pub. No.: US 2018/0282172 A1
(43) Pub. Date: Oct. 4, 2018

(54) PRODUCTION OF PRECIPITATED CALCIUM CARBONATE (PCC)

(71) Applicant: COATEX, Genay (FR)

(72) Inventor: Christian JACQUEMET, Lyon (FR)

(73) Assignee: COATEX, Genay (FR)

(21) Appl. No.: 15/763,997

(22) PCT Filed: Oct. 13, 2016
(86) PCT No.: PCT/FR2016/052645

§ 371 Date: Mar. 28, 2018

(30) Foreign Application Priority Data
Oct. 16, 2015 (FR) 1559898

(51) Int. Cl. C01F 11/18; C08F 212/08; C08F 222/08; C04B 2/06; C09C 1/02

(52) U.S. Cl. CPC C01F 11/183; C08F 212/08; C08F 222/08; C01P 2006/22; C09C 1/021; C08F 2800/10; C04B 2/06

(57) ABSTRACT

The invention relates to the use of copolymers obtained by the polymerisation of styrene maleic anhydride, functionalised or not, for producing an aqueous suspension of precipitated calcium carbonate (PCC) by slaking a material containing calcium oxide in water then by carbonation of the milk of lime thus produced.

The present invention relates to the use of copolymers obtained by polymerization of maleic anhydride and of styrene, which may or may not be functionalized, for preparing a Precipitated Calcium Carbonate (PCC) aqueous suspension, said copolymers being optionally used in combination with at least one slaking additive.

### CONTEXT OF THE INVENTION

Calcium carbonate is one of the most widely used additives in the paper, paint and plastics industries. Natural Calcium Carbonate (NCC) is, for example, used as mineral filler in numerous applications. For its part, Precipitated Calcium Carbonate (PCC) can be manufactured tailor-made in terms of morphology and particle size distribution, which confers specific properties on the materials which contain it. Scalenohedral Precipitated Calcium Carbonate (S-PCC) is used in particular as mineral filler in combination with cellulose fibers in filler applications in paper.

The methods for the production of PCC comprise the steps consisting of the slaking of a calcium oxide containing material (generally known as “quicklime”) with water, so as to produce a calcium hydroxide suspension (generally known as “lime milk”), followed by the subsequent synthesis of the calcium carbonate by circulating carbon dioxide through said resulting calcium hydroxide suspension. Such methods produce PCC suspensions with a low dry solids content. Consequently, these methods generally comprise an additional concentration step in order to obtain a PCC suspension having a higher solids content, which is advantageous during the transportation of the PCC suspension. Nevertheless, such additional concentration steps are energy-consuming, cost-intensive and necessitate having to resort to a specific item of equipment (for example a centrifuge, requiring high maintenance). Furthermore, the use of such items of equipment can result in the destruction of the structure of the PCC formed, as is in particular the case with S-PCC prepared in the form of clusters, for example.

Methods for the preparation of PCC in the presence of various additives are described in the literature.

A certain number of documents are concerned with the preparation of PCC in the presence of negatively charged polymers, for example (meth)acrylic acid polymers.

In particular, document WO 2005/000742 A1 relates to a method for the preparation of lamellar PCC comprising the steps consisting in providing a calcium hydroxide suspension, carbonating said suspension, and in adding a polyacrylate to the suspension before the end of the carbonation in order to precipitate the lamellar calcium carbonate. Also, the unpublished patent application EP 14166751.9, filed in the name of the present applicants, relates to the use of a combination of at least one water-soluble polymer (for example a polyacrylic acid) and of at least one slaking additive in a method for the production of a precipitated calcium carbonate aqueous suspension.

Other documents describe the use of positively charged additives prepared, for example, from monomeric units having a quaternary amine.

The unpublished patent application FR 15 51690, filed in the name of the present applicants, relates to the use of a cationic polymer, optionally in the presence of a slaking additive, in a method for the production of a precipitated calcium carbonate aqueous suspension. The invention described in this document makes it possible to prepare PCC suspensions with cationic surface charges, even at alkaline pH values.

Finally, other documents are concerned with the use of at least partially biosourced additives. For example, patent application WO 2007/067146 A1 describes a method for the preparation of PCC in the presence of starch or of carboxymethylcellulose (CMC).

The unpublished patent application FR 15 56789, filed in the name of the present applicants, is concerned with the use of a solution of depolymerized carboxylated cellulose for preparing a Precipitated Calcium Carbonate (PCC) aqueous suspension, said solution of depolymerized carboxylated cellulose having a solids content of between 25% and 40% by weight based on the total weight of the solution, and said depolymerized carboxylated cellulose having a molecular weight of between 10 000 g/mol and 40 000 g/mol, in a method for the production of a precipitated calcium carbonate aqueous suspension.

Document FR 3017872 describes a method for the preparation of particles by dry grinding of natural calcium carbonate and not of PCC.

Document WO 99 51691 describes a method for the preparation of PCC which comprises a step of removing water in order to increase the concentration.

Document EP 0467287 describes the preparation of a dispersion of PCC which uses a maleic anhydride copolymer but does not disclose the use of such a polymer during the preparation of the PCC as such.

### OBJECTS OF THE INVENTION

One object of the present invention is to provide a solution for the production of PCC suspensions with, for example, a high dry solids content, without having recourse to an additional step of thermal or mechanical concentration.

Another object of the present invention is to provide a solution for the production of PCC suspensions with a high dry solids content possessing viscosities which can easily be managed, that is to say a solution which makes it possible to increase the dry solids content of the PCC suspensions, while preventing an increase in the viscosity of the suspensions.

It is also desirable for said solution not to negatively affect the kinetics of the carbonation step and/or not to detrimentally affect the crystallographic structure of the PCC.

Another object of the present invention is to provide a solution for the preparation of PCC suspensions to be used directly as mineral filler in a method for the manufacture of paper.

### BRIEF DESCRIPTION OF THE INVENTION

The present invention relates to the use of copolymers obtained by polymerization of maleic anhydride and of styrene, which may or may not be functionalized, for preparing a Precipitated Calcium Carbonate (PCC) aqueous suspension by slaking a calcium oxide containing material in water then carbonating the lime milk thus obtained.

The present invention also relates to the use of a combination of at least one copolymer obtained by polymerization of maleic anhydride and of styrene, which may or may not be functionalized, and of at least one slaking additive in a method for the production of a precipitated calcium carbonate aqueous suspension.

The present invention also relates to the use of copolymers obtained by polymerization of maleic anhydride and of styrene, which may or may not be functionalized, for preparing Precipitated Calcium Carbonate (PCC) in dry form, by slaking a calcium oxide containing material in water, carbonating the lime milk thus obtained and at least drying the PCC suspension.

### DETAILED DESCRIPTION OF THE INVENTION

### Definitions

For the purposes of the present invention, the terms cited below should be understood as having the following meanings:

“Calcium oxide containing material” is understood to mean a mineral or synthetic material with a calcium oxide content of at least 50 wt. %, for example of at least 75 wt. % or at least 90 wt. % or else at least 95 wt. % based on the total weight of the calcium oxide containing material.

“Mineral material” is understood to mean a solid substance with a defined inorganic chemical composition and a characteristic crystalline and/or amorphous structure.

“Natural Calcium Carbonate (NCC)” is understood to mean a calcium carbonate obtained from natural sources, such as limestone, marble or chalk, and subjected to a wet and/or dry treatment, such as a grinding, a sieving and/or a split, for example using a cyclone or a sorter.

“Precipitated Calcium Carbonate (PCC)” is understood to mean a synthetic material generally obtained by precipitation subsequent to the reaction of carbon dioxide and of calcium hydroxide (hydrated lime) in an aqueous medium or by precipitation of a source of calcium and of a source of carbonate in water. Moreover, the precipitated calcium carbonate can also be the product which makes it possible to introduce calcium and carbonate salts, calcium chloride and sodium carbonate, for example in an aqueous medium. The PCC can be in the vaterite, calcite or aragonite form. PCCs are described, for example, in documents EP 2447213 A1, EP 2524898 A1 and EP 2371766 A1.

For the purposes of the present invention, the “dry solids content” or “solids content” of a liquid composition is a measure of the remaining amount of material after evaporation of all the solvents or of water.

Throughout the present document, the “particle size distribution” of the precipitated calcium carbonate or of the other particulate materials is described by its part granulometric distribution. The value dₓ represents the diameter for which x % by weight of the particles have a diameter of less than dₓ. This means that the value d₂₀ is the particle size distribution at which 20% by weight of all the particles have a diameter of less than the value d and the value d₉₈ is the particle size distribution at which 98% by weight of all the particles have a diameter of less than the value d. The value d₉₈ is also known as the “top cut”. The value d₅₀ is known as the weight median particle size distribution, that is to say that 50% by weight of the particles have a diameter of less than or greater than this particle size distribution. For the purposes of the present invention, the particle size distribution is indicated as being the weight median particle size distribution d₅₀ unless otherwise indicated. To determine the weight median particle size distribution d₅₀ or the particle size distribution of the top cut d₉₈, a Sedigraph 5100 or 5120 device from Micromeritics, USA, can be used.

A “Specific Surface Area according to the BET method (SSA)”, within the meaning of the present invention, is defined as being the surface area of the precipitated calcium carbonate particles divided by the mass of the PCC particles. As used here, the specific surface area is measured by N₂ adsorption using BET isotherms (ISO 9277:1995) and is indicated in m²/g.

Within the meaning of the present invention, “stable in an aqueous suspension with a pH of 12 and a temperature of 90° C.” means that the polymeric additive retains its physical properties and its chemical structure when it is added to an aqueous suspension with a pH of 12 and a temperature of 90° C. For example, the polymeric additive retains its dispersing qualities and is not depolymerized or degraded under said conditions.

For the purposes of the present invention, the term “viscosity” or “Brookfield viscosity” refers to the Brookfield viscosity. The Brookfield viscosity is measured using a Brookfield viscometer (RVT type) at 25° C.±1° C. at 100 rev/min using an appropriate spindle and is indicated in mPa·s.

For the purposes of the present invention, “water-soluble” materials are defined as being materials which, when they are mixed with deionized water and filtered through a filter with a pore size of 0.2 μm at 20° C. in order to recover the liquid filtrate, result in a mass of less than or equal to 0.1 g of solid material recovered after evaporation of 100 g of said liquid filtrate between 95° C. and 100° C. The “water-soluble” materials are defined as being materials which result in a mass of greater than 0.1 g of solid material recovered after evaporation of 100 g of said liquid filtrate between 95° C. and 100° C.

A “suspension”, within the meaning of the present invention, comprises insoluble solids and water, and optionally other additives. It is capable of containing large amounts of solids and thus of being more viscous and of having a greater density than that of the liquid from which it is formed.

The term “comprising” as used in the present description and the present claims, does not exclude other elements. For the purposes of the present invention, the term “consisting of” is regarded as being a preferred embodiment of the term “comprising”. If a group is defined hereinafter as comprising at least a certain number of embodiments, it should also be understood that it describes a group which preferably consists only of these embodiments.

The terms “which can be obtained” or “which can be defined” and “obtained” or “defined” are used interchangeably. For example, this means that, unless the context stipulates otherwise, the term “obtained” does not indicate that an embodiment has to be obtained by the sequence of steps following the term “obtained”, even if such a limited understanding is always included by the term “obtained” or “defined” as a preferred embodiment.

### Copolymers According to the Invention

The copolymers in question in the context of the present invention result from the polymerization of maleic anhydride monomers and of styrene monomers. By way of illustration, mention is made of copolymers of maleic anhydride and of styrene of low molecular weight and their derivatives.

The copolymers may be derivatives of these copolymers, for example derivatives of copolymers of maleic anhydride and of styrene having:
partially or totally hydrolyzed maleic anhydride units and/or
partially or totally esterified maleic anhydride units and/or
partially or totally amidated maleic anhydride units and/or
partially or totally imidized maleic anhydride units and/or
partially or totally sulfonated styrene units.

According to one embodiment, for preparing a Precipitated Calcium Carbonate (PCC) aqueous suspension by the slaking of a calcium oxide containing material in water then carbonating the lime milk thus obtained, use is made of such copolymers of the following formula (I):

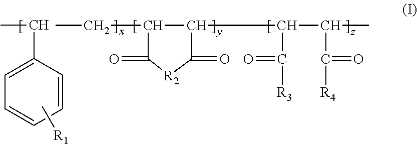

in which:
x, y and z units are arranged in blocks, randomly, alternately or statistically,
x is non-zero and at least one of y or z is also non-zero, the sum of x+y+z being less than or equal to 150,
R₁ represents H or a sulfonated group,
R₂ represents a heteroatom, optionally substituted with an alkyl chain, an alkenyl chain, a heteroalkyl chain and/or a polyalkoxylated chain,
R₃ and R₄, independently of one another, represent OH, (O⁻, M⁺), an O-alkyl chain comprising between 1 and 20 carbon atoms, an N-alkyl chain comprising between 1 and 20 carbon atoms and/or a polyalkoxylated chain and
M⁺ represents a monovalent, divalent or trivalent cation.

In the context of the present invention:
“sulfonated group” is understood to mean an —SO₃H or —(SO₃⁻, M⁺) group,
“heteroatom” is understood to mean an oxygen, sulfur, nitrogen, silicon or phosphorus atom,
“alkyl” is understood to mean a linear, branched or cyclic, saturated carbon radical which is optionally substituted and which comprises from 1 to 20 carbon atoms,
“alkenyl” is understood to mean a linear, branched or cyclic carbon radical comprising one or more unsaturations, which is optionally substituted and which comprises from 2 to 20 carbon atoms,
“heteroalkyl” is understood to mean an alkyl radical as defined above, said alkyl system comprising at least one heteroatom, in particular chosen in the group comprising sulfur, oxygen, nitrogen, phosphorus and silicon and
“polyalkoxylated chain” is understood to mean a chain of [(EO)ₙ(PO)_{n′}(BO)_{n″}]—Z type, consisting of alkoxylated units, distributed in blocks, randomly, alternately or statistically, chosen from ethoxylated units EO, propoxylated units PO and butoxylated units BO, n, n′, n″ representing, independently of one another, 0 or an integer ranging from 1 to 150, the sum of n, n′ and n″ not being zero, and Z represents an alkyl chain comprising between 1 and 20 carbon atoms, for example 1 or 2 carbon atom(s).

The copolymers according to the invention are obtained by polymerization of at least two different monomers, according to known and described methods.

The x units in formula (1) are derived from polymerizable monomers of styrene type, optionally modified before or after polymerization. The x units can in particular be subjected to a total or partial sulfonation, after polymerization. Thus, the copolymer according to the invention can comprise styrene units as such and/or styrene units substituted by a sulfonated group.

The y and z units for their part, are derived from maleic anhydride monomers, optionally modified before or after polymerization.

According to one embodiment of the present invention, the copolymer consists of x units and of y units.

According to another embodiment of the present invention, the copolymer consists of x units and of z units.

According to yet another embodiment, the copolymer consists of x units and of y units and of z units.

Finally, according to one embodiment of the present invention, the copolymer consists of x units of styrene type, and also of x units of sulfonated styrene type and of y and z units. The molar ratio between, on the one hand, the x units and, on the other hand, the y and/or z units, within the copolymer, can range between 10:1 and 1:2 or between 5:1 and 1:2. For example, the molar ratio between, on the one hand, the x units and, on the other hand, the y and/or z units, within the copolymer, is 1:1, 2:1 or 3:1.

Said copolymers or derivatives used in the context of the present invention are in acid form or in neutralized form.

When they are neutralized, the copolymers according to the invention are totally or partially neutralized.

In formula (I) above, or in formula (III) below, M⁺ is for example chosen from calcium (Ca²⁺), magnesium (Mg²⁺), lithium (Li⁺), sodium (Na⁺), potassium (K⁺) and ammonium (NH₄⁺). M⁺ can also be an ammonium. The degree of neutralization and the concentration of the polymer can be adjusted so that the polymer remains soluble.

According to one embodiment of the present invention, for preparing a Precipitated Calcium Carbonate (PCC) aqueous suspension by the slaking of a calcium oxide containing material in water then carbonating the lime milk thus obtained, use is made of a copolymer of the following formula (II):

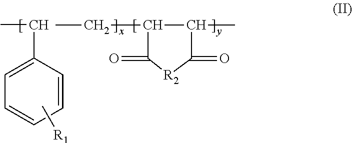

in which:
x and y units are arranged in blocks, randomly, alternately or statistically,
x and y are non-zero, the sum of x+y being less than or equal to 150,
R₁ represents H or a sulfonated group and
R₂ represents a heteroatom, optionally substituted by an alkyl chain, an alkenyl chain, a heteroalkyl chain and/or a polyalkoxylated chain.

According to another embodiment, for preparing a Precipitated Calcium Carbonate (PCC) aqueous suspension by the slaking of a calcium oxide containing material in water then carbonating the lime milk thus obtained, use is made of a copolymer of the following formula (III):

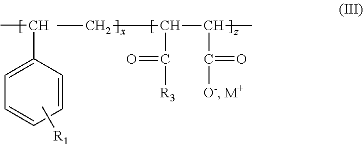

in which:
x and z units are arranged in blocks, randomly, alternately or statistically,
x and z are non-zero, the sum of x+z being less than or equal to 150,
R₁ represents H or a sulfonated group,
R₃ represents OH, (O⁻, M⁺), an O-alkyl chain comprising between 1 and 20 carbon atoms, an N-alkyl chain comprising between 1 and 20 carbon atoms and/or a polyalkoxylated chain and
M⁺ represents a monovalent, divalent or trivalent cation.

According to another embodiment, for preparing a Precipitated Calcium Carbonate (PCC) aqueous suspension by the slaking of a calcium oxide containing material in water then carbonating the lime milk thus obtained, use is made of a copolymer of formula (I) in which x, y and z are non-zero and less than 150, x, y and z units being arranged in blocks, randomly, alternately or statistically.

Throughout the present description, the R₂ group represents a heteroatom, optionally substituted by an alkyl chain, an alkenyl chain, a heteroalkyl chain and/or a polyalkoxylated chain.

According to one embodiment, the R₂ group represents an O atom.

According to another embodiment, the R₂ group represents an N atom substituted by an alkyl chain, an alkenyl chain, a heteroalkyl chain and/or a polyalkoxylated chain. The N atom can in particular be substituted by an alkyl chain bearing a primary, secondary or tertiary ammonium function.

By way of example, the R₂ group represents N—CH₂—CH₂—N(CH₃)₂.

Throughout the present description, the R₃ and R₄ groups, independently of one another, represent OH, (O⁻, M⁺), an O-alkyl chain comprising between 1 and 20 carbon atoms, an N-alkyl chain comprising between 1 and 20 carbon atoms and/or a polyalkoxylated chain.

According to one embodiment, the R₃ and R₄ groups represent (O⁻, M⁺), for example (O⁻, NH₄⁺).

According to another embodiment, one of the R₃ and R₄ groups represents OH and the other represents an O-alkyl chain comprising between 1 and 20 carbon atoms.

According to yet another embodiment, one of the R₃ and R₄ groups represents (O⁻, M⁺), for example (O⁻, NH₄⁺), and the other represents an O-alkyl chain comprising between 1 and 20 carbon atoms.

According to another embodiment, the copolymer is such that it comprises two different types of z units. According to this embodiment, a part of the z units of the copolymer according to the invention is such that the R₃ and R₄ groups represent (O⁻, M⁺), for example

(O⁻, NH₄⁺). Another part of the z units of the copolymer is such that one of the R₃ and R₄ groups represents (O⁻, M⁺), for example (O⁻, NH₄⁺), and the other represents an O-alkyl chain comprising between 1 and 20 carbon atoms.

According to yet another embodiment, one of the R₃ and R₄ groups represents (O⁻, M⁺), for example (O⁻, NH₄⁺) and the other represents a polyalkoxylated chain, for example —C₄H₈—O—CH₂—CH₃.

According to one embodiment, the copolymer according to the invention is in solution form, in powder form, in resin form or in flake form.

According to one embodiment of the present invention, the copolymers have a molecular weight of less than 100,000 g/mol, for example less than 50,000 g/mol or less than 15,000 g/mol or less than 12,000 g/mol.

According to one embodiment of the present invention, the copolymers have a molecular mass greater than 1,000 g/mol.

The molecular weight of the copolymers according to the invention is determined by Size Exclusion Chromatography (SEC).

### Calcium Oxide Containing Material

The PCC aqueous suspension is prepared by the slaking of a calcium oxide CaO containing material. Thus, in the method for the production of a precipitated calcium carbonate aqueous suspension, a calcium oxide containing material is provided. Said calcium oxide containing material can be obtained by calcining a calcium carbonate containing material. Calcination is a heat treatment method applied to the calcium carbonate containing material in order to bring about a thermal decomposition resulting in the formation of calcium oxide and carbon dioxide gas. The calcium carbonate containing materials that can be used in such a calcination method are those chosen in the group comprising precipitated calcium carbonates, natural minerals containing calcium carbonate, such as marble, limestone and chalk, and minerals containing a mixture of alkaline-earth metal carbonates comprising calcium carbonate, such as dolomite or fractions rich in calcium carbonate originating from other sources. It is also possible to subject a waste material containing calcium carbonate to a calcination method in order to obtain a calcium oxide containing material.

Calcium carbonate decomposes at approximately 1,000° C. to give calcium oxide (commonly known as quicklime). The calcination step can be carried out under conditions and using items of equipment well known to the person skilled in the art. As a general rule, the calcination can be carried out in furnaces or reactors (sometimes known as kilns) of various designs, in particular shaft furnaces, rotary kilns, multiple half furnaces and fluidized bed reactors.

The end of the calcination reaction can be determined, for example, by monitoring the change in density, the residual content of carbonate, for example by X-ray diffraction, or the reactivity of the slaking by standard methods.

According to one embodiment of the present invention, the calcium oxide containing material is obtained by calcining a calcium carbonate containing material, for example chosen in the group consisting of precipitated calcium carbonate, natural minerals containing calcium carbonate, such as marble, limestone and chalk, minerals containing a mixture of alkaline-earth metal carbonates comprising calcium carbonate, such as dolomite or their mixtures.

For reasons of effectiveness, it is preferable for the calcium oxide containing material to have a minimum content of calcium oxide of at least 75% by weight, preferably at least 90% by weight and particularly preferably 95% by weight, based on the total weight of the calcium oxide containing material. According to one embodiment, the calcium oxide containing material consists of calcium oxide.

The calcium oxide containing material can consist of just one type of calcium oxide containing material. Alternatively, the calcium oxide containing material can consist of a mixture of at least two types of calcium oxide containing material.

The calcium oxide containing material can be used in the method of the invention in its original form, that is to say in the raw material form, for example in the form of more or less large chunks. Alternatively, the calcium oxide containing material can be ground before use. According to one embodiment of the present invention, the calcium oxide containing material is in the form of particles with a weight median particle size distribution d₅₀ ranging from 0.1 μm to 1,000 μm and, for example, from 1 μm to 500 μm.

Use of Copolymers Obtained by Polymerization of Maleic Anhydride and of Styrene, which May or May not be Functionalized

The present invention relates to the use of copolymers obtained by polymerization of maleic anhydride and of styrene, which may or may not be functionalized, for preparing a Precipitated Calcium Carbonate (PCC).

More specifically, the present invention relates to the use of copolymers obtained by polymerization of maleic anhydride and of styrene, which may or may not be functionalized, for preparing a Precipitated Calcium Carbonate (PCC) in dry form or in the form of an aqueous solution or aqueous suspension.

Without wishing to be bound by any theory, it may be considered that such copolymers modify the surface tension of dry calcium carbonates (as obtained by slaking and carbonating then drying), such that they improve in particular the dispersion of the pigment filler within the plastic matrix.

The methods for the production of a PCC aqueous suspension generally comprise the steps consisting in (i) preparing a lime milk by mixing water and the calcium oxide containing material, and optionally the at least one slaking additive, and (ii) carbonating the lime milk obtained in step (i) so as to form a precipitated calcium carbonate aqueous suspension.

“Carbonating” is understood to mean circulating carbon dioxide through the suspension of calcium hydroxide Ca(OH)₂, so as to form precipitated calcium carbonate CaCO₃.

According to the present invention, at least one copolymer obtained by polymerization of maleic anhydride and of styrene, which may or may not be functionalized, is used for preparing a Precipitated Calcium Carbonate (PCC) aqueous suspension by the slaking of a calcium oxide containing material in water then carbonating the lime milk thus obtained.

### Slaking Step

In the first step of the method for the production of PCC, that is to say “the slaking step” (called step i) above), a lime milk is prepared by mixing water, the calcium oxide containing material, the copolymers obtained by polymerization of maleic anhydride and of styrene, which may or may not be functionalized, and optionally the at least one slaking additive.

The reaction of the calcium oxide containing material with water results in the formation of a milky calcium hydroxide suspension, better known as lime milk. Said reaction is highly exothermic and is also known in the art as “lime slaking”.

According to one embodiment, said copolymers obtained by polymerization of maleic anhydride and of styrene, which may or may not be functionalized, are present in the slaking water of the calcium oxide containing material.

According to one embodiment of the present invention, the temperature of the water, which is used in the slaking step, that is to say the temperature of the water which is used for the slaking of the calcium oxide containing material, is adjusted in order to be within the range extending from 0° C. to 100° C., for example from 1° C. to 70° C. or from 2° C. to 50° C. or from 30° C. to 50° C. or from 35° C. to 45° C. It will appear obvious to the person skilled in the art that the initial temperature of the water is not necessarily the same as the temperature of the mixture prepared in the slaking step as a result of the highly exothermic nature of the slaking reaction and/or of the mixing of substances with different temperatures.

According to one embodiment of the present invention, the slaking step of the method comprises the steps consisting in:
a1) mixing the copolymers obtained by polymerization of maleic anhydride and of styrene, which may or may not be functionalized, with water and optionally the at least one slaking additive and
a2) adding the calcium oxide containing material to the mixture of step a1). According to one embodiment, step a1) is carried out at a temperature of between 0° C. and 99° C., for example between 1° C. and 70° C. or between 2° C. and 50° C. or between 30° C. and 50° C. or between 35° C. and 45° C.

According to another embodiment of the present invention, the slaking step of the method comprises the steps consisting in:
b1) mixing the calcium oxide containing material, the copolymers obtained by polymerization of maleic anhydride and of styrene, which may or may not be functionalized, and optionally the at least one slaking additive and
b2) adding water to the mixture of step b1).

According to yet another embodiment of the present invention, in the slaking step of the method, the calcium oxide containing material, the copolymers obtained by polymerization of maleic anhydride and of styrene, which may or may not be functionalized, optionally the at least one slaking additive and water are mixed simultaneously.

According to yet another embodiment of the present invention, the at least one slaking additive is added before or after the slaking step of the method.

The copolymers obtained by polymerization of maleic anhydride and of styrene, which may or may not be functionalized, can be added in the slaking step in their entirety or in several parts, for example in two, three, four, five or more parts.

The slaking step of the method can be carried out at ambient temperature, that is to say at a temperature of 20° C.±2° C., or at an initial temperature of between 30° C. and 50° C. or between 35° C. and 45° C. Since the reaction is exothermic, the temperature generally reaches a temperature of between 85° C. and 99° C. during step i), preferably a temperature of between 90° C. and 95° C. According to one preferred embodiment, step i) of the method is carried out by mixing or by stirring, for example with mechanical stirring. The appropriate item of equipment for the mixing or the stirring of the method is known to the person skilled in the art.

The progression of the slaking reaction can be observed by measuring the temperature and/or the conductivity of the reaction mixture.

The inventors have found, with surprise, that the addition of copolymers obtained by polymerization of maleic anhydride and of styrene, which may or may not be functionalized, as previously defined, and optionally of a slaking additive as previously defined, before or during the slaking step of a method for the production of PCC, can make possible the preparation not only of a lime milk with a low dry solids content, but also of a lime milk with a high dry solids content. Indeed, it is interesting to note that, according to one aspect of the invention, by carbonating said highly concentrated lime milk, it is possible to obtain a PCC aqueous suspension which also has a high dry solids content. Consequently, the method of the present invention does not require an additional concentration step in order to obtain a PCC suspension with a high dry solids content.

According to one embodiment of the present invention, the lime milk of the slaking step has a dry solids content of at least 8% by weight, for example ranging from 10% to 66% by weight or from 15% to 45% by weight or for example from 20% to 40% by weight or for example from 25% to 37% by weight, based on the total weight of the lime milk.

According to one embodiment of the present invention, the lime milk of the slaking step has a Brookfield viscosity ranging from 1 mPa·s to 1,000 mPa·s at 25° C., for example from 5 mPa·s to 800 mPa·s at 25° C. or for example from 10 mPa·s to 500 mPa·s at 25° C., as measured at 100 rpm.

According to another embodiment of the present invention, the lime milk of the slaking step has a Brookfield viscosity ranging from 1 mPa·s to 1,000 mPa·s at 25° C., for example from 5 mPa·s to 800 mPa·s at 25° C. or for example from 10 mPa·s to 500 mPa·s at 25° C., as measured at 100 rpm, at a dry solids content of at least 8% by weight, for example ranging from 10% to 66% by weight or from 15% to 45% by weight or for example from 20% to 40% by weight or for example from 25% to 37% by weight, based on the total weight of the lime milk.

In the context of the present invention, additional water can be introduced during the slaking reaction in order to control and/or maintain and/or reach the desired dry solids content or the desired Brookfield viscosity of the lime milk.

The slaking step of the method can be carried out in the form of a batchwise, semi-batchwise or continuous processing.

In the slaking step, the calcium oxide containing material and the water can be mixed in a weight ratio from 1:1 to 1:12, for example from 1:2 to 1:12, for example from 1:2.5 to 1:6.

According to one embodiment, said copolymers obtained by polymerization of maleic anhydride and of styrene, which may or may not be functionalized, are used in combination with at least one slaking additive.

In this case, the at least one slaking additive can be chosen in the group consisting of organic acids, organic acid salts, sugar alcohols, monosaccharides, disaccharides, polysaccharides, gluconates, phosphonates, lignosulfonates and their mixtures.

According to one embodiment, the at least one slaking additive is chosen in the group consisting of sodium citrate, potassium citrate, calcium citrate, magnesium citrate, monosaccharides, disaccharides, polysaccharides, sucrose, sugar alcohols, meritol, citric acid, sorbitol, sodium salt of diethylenetriamine pentaacetic acid, gluconates, phosphonates, sodium tartrate, sodium lignosulfonate, calcium lignosulfonate and their mixtures.

### Carbonation Step

In this step of the method for the production of PCC, that is to say the carbonation step (called step ii) above), the lime milk obtained at the end of the slaking step is carbonated in order to form a precipitated calcium carbonate aqueous suspension.

The carbonation is carried out by means and under conditions well known to the person skilled in the art. The introduction of carbon dioxide into the lime milk rapidly increases the concentration of carbonate (CO₃²⁻) ions and calcium carbonate is formed. In particular, the carbonation reaction can be easily controlled by taking into account the reactions involved in the carbonation method. The carbon dioxide dissolves, according to its partial pressure, to form carbonate ions via the formation of carbonic acid (H₂CO₃) and of hydrogenocarbonate (HCO₃⁻) ions which are unstable in alkaline solution. During the continuous dissociation of the carbon dioxide, the hydroxide ions are consumed and the concentration of carbonate ions increases until the concentration of dissolved calcium carbonate is greater than the solubility product and the solid calcium carbonate precipitates.

According to one embodiment of the present invention, the carbonation is carried out by incorporating pure carbon dioxide gas or industrial gases containing at least 10 vol. % of carbon dioxide in the lime milk.

The progression of the carbonation reaction can be easily observed by measuring the conductivity and/or the pH. In this regard, the pH of the lime milk before the addition of carbon dioxide will be greater than 10, generally between 11 and 12.5, and will continually decrease until a pH of approximately 7 is obtained. The reaction can then be stopped.

The conductivity slowly decreases during the carbonation reaction and then rapidly decreases to reach low values when the precipitation is complete. The progression of the carbonation can be monitored by measuring the pH and/or the conductivity of the reaction mixture.

According to one embodiment of the method for the production of PCC, the temperature of the lime milk obtained at the end of the slaking step, which is used in the carbonation step, is adjusted in order to be within the range extending from 20° C. to 60° C. and, for example, from 30° C. to 50° C. It will be clearly apparent for the person skilled in the art that the initial temperature of the lime milk is not necessarily the same as the temperature of the mixture prepared in the carbonation step as a result of the exothermic nature of the carbonation reaction and/or of the mixing of substances with different temperatures.

According to one embodiment of the method for the production of PCC, the carbonation step is carried out at a temperature of between 5° C. and 95° C., for example from 30° C. to 70° C. and for example from 40° C. to 60° C.

The carbonation step of the method can be carried out in the form of a batchwise, semi-batchwise or continuous processing. According to one embodiment, the method for the production of PCC involving the slaking and carbonation steps of the method is carried out in the form of a batchwise, semi-batchwise or continuous processing.

According to one embodiment of the present invention, the method for the production of PCC does not comprise a step of concentrating the precipitated calcium carbonate aqueous suspension obtained in the slaking and carbonation steps of the method.

Thus, the present invention relates to the use of copolymers obtained by polymerization of maleic anhydride and of styrene, which may or may not be functionalized, in a method for the preparation of PCC, more specifically in the step of preparing a lime milk which has to be subsequently carbonated.

Without wishing to be bound to any theory, it may be thought that the affinity of the PCC particles formed during the method described above with the cellulose fibers or fibrils of the paper sheet is improved as a result of the use of said copolymers obtained by polymerization of maleic anhydride and of styrene, which may or may not be functionalized, during the method for the production of PCC.

Mütek charge and Zeta potential

According to one embodiment of the present invention, the use of copolymers obtained by polymerization of maleic anhydride and of styrene, which may or may not be functionalized, during the method for the preparation of PCC, confers on the PCC aqueous suspensions produced a Zeta potential of less than 4 mV, for example of less than 0 mV, but greater than the Zeta potential of a PCC prepared in the presence of negatively charged polymers, for example (meth)acrylic acid polymers, in particular those described in application WO 2005/000742 A1, which remains an advantage for the filler application.

According to another embodiment, the PCC aqueous suspensions obtained using the copolymers obtained by polymerization of maleic anhydride and of styrene, which may or may not be functionalized, are characterized in that they have a Zeta potential of less than 4 mV, for example of less than 0 mV, for example of between 0 mV and −40 mV, for example between 0 mV and −30 mV.

According to one embodiment, the use of copolymers obtained by polymerization of maleic anhydride and of styrene, which may or may not be functionalized, during the method for the preparation of the PCC confers, on the PCC aqueous suspensions produced, a Mütek charge of less than 0 μeq/g.

According to another embodiment, the PCC aqueous suspensions obtained using the copolymers obtained by polymerization of maleic anhydride and of styrene, which may or may not be functionalized, are characterized in that they have a Mütek charge of less than 0 μeq/g of suspension (as it is), for example of between 0 μeq/g and −1 μeq/g or between 0 μeq/g and −0.8 μeq/g.

According to one embodiment of the present invention, the copolymers obtained by polymerization of maleic anhydride and of styrene, which may or may not be functionalized, are added during the first step of the method for the production of PCC, that is to say that the copolymers obtained by polymerization of maleic anhydride and of styrene, which may or may not be functionalized, are added before or during the slaking step. The lime milk, known to the person skilled in the art, obtained by the slaking of a calcium oxide containing material with water generally has a pH of between 11 and 12.5 measured at a temperature of 25° C. according to the concentration of the calcium oxide containing material in the lime milk. Given that the slaking reaction is exothermic, the temperature of the lime milk can reach a temperature greater than 80° C., for example of between 80° C. and 99° C. According to one embodiment, the copolymers obtained by polymerization of maleic anhydride and of styrene, which may or may not be functionalized, used in the context of the present invention are chosen so as to be stable in an aqueous suspension with a pH of 12 and a temperature of 90° C. Within the meaning of the present invention, “stable in an aqueous suspension with a pH of 12 and a temperature of 90° C.” means that the polymeric additives retain their physical properties and their chemical structure when they are added to an aqueous suspension with a pH of 12 and a temperature of 90° C. For example, the polymeric additives retain their dispersing qualities and are not degraded under said conditions.

According to one embodiment of the present invention, the copolymers obtained by polymerization of maleic anhydride and of styrene, which may or may not be functionalized, are added in an amount ranging from 0.01% by weight to 2% by weight, for example from 0.02% by weight to 1% by weight and for example from 0.05% by weight to 0.5% by weight, based on the total weight of the calcium oxide containing material.

### Slaking Additive

In the first step of the method for the production of PCC (or slaking step), at least one slaking additive can be used in addition to the copolymers obtained by polymerization of maleic anhydride and of styrene, which may or may not be functionalized.

Thus, according to one embodiment, said copolymers obtained by polymerization of maleic anhydride and of styrene, which may or may not be functionalized, are used in combination with at least one slaking additive.

The at least one slaking additive can be chosen in the group consisting of organic acids, organic acid salts, sugar alcohols, monosaccharides, disaccharides, polysaccharides, gluconates, phosphonates, lignosulfonates and their mixtures.

According to one embodiment of the present invention, the at least one slaking additive is chosen in the group consisting of sodium citrate, potassium citrate, calcium citrate, magnesium citrate, monosaccharides, disaccharides, polysaccharides, sucrose, sugar alcohols, meritol, citric acid, sorbitol, sodium salt of diethylenetriamine pentaacetic acid, gluconates, phosphonates, sodium tartrate, sodium lignosulfonate, calcium lignosulfonate and their mixtures. According to one preferred embodiment, the at least one slaking additive is sodium citrate and/or sucrose.

According to one embodiment of the present invention, the at least one slaking additive used consists of a single type of slaking additive. Alternatively, the at least one slaking additive used can consist of a mixture of at least two types of slaking additives.

The at least one slaking additive can be added in an amount ranging from 0.01% by weight to 2% by weight, based on the total amount of calcium oxide containing material, for example in an amount ranging from 0.05% by weight to 1% by weight, for example from 0.06% by weight to 0.8% by weight or for example from 0.07% by weight to 0.5% by weight.

The addition of a slaking additive can be useful for controlling the size of the PCC particles and their crystalline morphology without affecting the viscosity of the aqueous suspension.

As was previously mentioned, the inventors have found, with surprise, that the addition of copolymers obtained by polymerization of maleic anhydride and of styrene, which may or may not be functionalized, as defined above, optionally in combination with the addition of a slaking additive before or during the slaking step of a method for the production of PCC can make possible the preparation of a PCC suspension with a high dry solids content. It is also believed that the omission of a concentration step improves the quality of the PCC particles produced, given that the surface damage of the particles, which may occur during the concentration step, is avoided. It is also estimated that said PCC suspension can be further concentrated up to a solids content of 52% by weight with acceptable viscosities, for example Brookfield viscosities of less than or equal to 1,000 mPa·s at 25° C. and at 100 rpm.

### Additional Steps of the Method

The method for the production of precipitated calcium carbonate can comprise additional steps.

The lime milk can be sieved in order to remove oversized particles. An appropriate sieve can comprise, for example, a sieve with a sieve size of 100 μm to 700 μm, for example approximately 100 μm or approximately 300 μm. According to one embodiment of the present invention, the lime milk is sieved after the slaking step and before the carbonation step, for example using a sieve with a sieve size ranging from 100 μm to 300 μm.

The method for the production of precipitated calcium carbonate can also comprise an additional step of separation of the precipitated calcium carbonate from the aqueous suspension obtained at the end of the carbonation step.

For the purposes of the present invention, the expression “separation” means that the PCC is removed or isolated from the aqueous suspension obtained in the carbonation step of the method. Any conventional separation means known to the person skilled in the art can be used, for example a mechanical and/or thermal means. Examples of mechanical separation methods are filtration, for example by means of a drum filter or of a filter press, nanofiltration or centrifugation. An example of a thermal separation method is a method for concentrating by application of heat, for example in an evaporator.

The PCC obtained can be transformed, for example deagglomerated or subjected to a dry grinding step. It can also be wet ground in the form of a suspension. If the PCC is subjected to dewatering, dispersing and/or grinding steps, these steps can be accomplished by methods known in the art. Wet grinding can be carried out in the absence or in the presence of a grinding aid agent. Dispersants can also be included in order to prepare dispersions, if appropriate.

The method for the production of precipitated calcium carbonate can also comprise an additional step of drying the precipitated calcium carbonate, for example separated precipitated calcium carbonate obtained at the end of the separation step described above. The term “drying” refers to a method according to which at least one portion of the water is removed from a material which has to be dried, so that a constant weight of the “dry” material obtained at 120° C. is achieved. Furthermore, a “dry” material can also be defined by its total moisture content which, unless otherwise indicated, is less than or equal to 1.0% by weight, preferably less than or equal to 0.5% by weight, more preferentially less than or equal to 0.2% by weight and above all preferably of between 0.03% by weight and 0.07% by weight, based on the total weight of the dry material.

In general, the drying step can be carried out using any appropriate item of drying equipment and can, for example, comprise thermal drying and/or drying under reduced pressure, using an item of equipment such as an evaporator, a flash drier, an oven, a spray drier and/or drying in a vacuum chamber.

The drying step results in a dry precipitated calcium carbonate with a low total moisture content which is less than or equal to 1.0% by weight, based on the total weight of the dry precipitated calcium carbonate.

The precipitated calcium carbonate obtained by the method of the invention can be post-treated, for example during and/or after a drying step, with an additional component. According to one embodiment, the precipitated calcium carbonate is treated with a fatty acid, for example stearic acid, a silane or fatty acid phosphoric esters.

According to one embodiment of the method for the production of PCC, the precipitated calcium carbonate obtained has a weight median particle size distribution d₅₀ ranging from 0.1 μm to 100 μm, for example from 0.25 μm to 50 μm, for example from 0.3 μm to 5 μm and, for example, from 0.4 μm to 3.0 μm.

The precipitated calcium carbonate can have an aragonite, calcite or vaterite crystalline structure or mixtures of these structures. Another advantage of the present invention is that the crystalline structure and the morphology of the precipitated calcium carbonate can be controlled, for example by adding seed crystals or other structure-modifying chemical products. According to one preferred embodiment, the precipitated calcium carbonate obtained by the method of the invention has a clustered scalenohedral crystalline structure.

The BET specific surface area of the precipitated calcium carbonate obtained by the method according to the present invention can range from 1 m²/g to 100 m²/g, for example from 2 m²/g to 70 m²/g, for example from 3 m²/g to 50 m²/g, for example from 4 m²/g to 30 m²/g, measured using nitrogen and the BET method in accordance with the ISO 9277 standard. The BET specific surface area of the precipitated calcium carbonate obtained by the method of the present invention can be controlled using additives, for example surfactants, which involve shearing during the precipitation step or subsequently high mechanical shear rates, resulting not only in a small particle size distribution but also in a high BET specific surface area.

According to one embodiment of the present invention, the precipitated calcium carbonate suspension obtained has a dry solids content of at least 10% by weight, for example ranging from 20% by weight to 50% by weight, for example from 25% by weight to 45% by weight or for example from 30% by weight to 40% by weight, based on the total weight of the suspension.

According to one embodiment of the present invention, the PCC suspension has a Brookfield viscosity of less than or equal to 1,500 mPa·s at 25° C., for example less than or equal to 1,000 mPa·s at 25° C. or less than or equal to 800 mPa·s at 25° C. or for example less than or equal to 600 mPa·s at 25° C. as measured at 100 rpm.

According to one embodiment of the present invention, when no slaking additive is used, the PCC suspension has a Brookfield viscosity of less than or equal to 2,500 mPa·s at 25° C., for example less than or equal to 2,000 mPa·s at 25° C. or less than or equal to 1,000 mPa·s at 25° C. or for example less than or equal to 800 mPa·s at 25° C. as measured at 100 rpm.

Another aspect of the present invention relates to the use of a combination of copolymers obtained by polymerization of maleic anhydride and of styrene, which may or may not be functionalized, and of a slaking additive in a method for the production of a precipitated calcium carbonate aqueous suspension, in which:
the copolymer has a following formula (I):

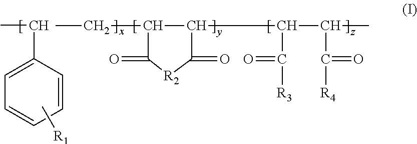

in which:
   x, y and z units are arranged in blocks, randomly, alternately or statistically,
   x is non-zero and at least one of y or z is also non-zero, the sum of x+y+z being less than or equal to 150,
   R₁ represents H or a sulfonated group,
   R₂ represents a heteroatom, optionally substituted by an alkyl chain, an alkenyl chain, a heteroalkyl chain and/or a polyalkoxylated chain,
   R₃ and R₄, independently of one another, represent OH, (O⁻, M⁺), an O-alkyl chain comprising between 1 and 20 carbon atoms, an N-alkyl chain comprising between 1 and 20 carbon atoms and/or a polyalkoxylated chain and
   M⁺ represents a monovalent, divalent or trivalent cation and
the slaking additive is chosen in the group consisting of organic acids, organic acid salts, sugar alcohols, monosaccharides, disaccharides, polysaccharides, gluconates, phosphonates, lignosulfonates and their mixtures.

According to one embodiment of the present invention, said precipitated calcium carbonate aqueous suspension thus obtained is used in formulations in the paper, plastics or paint technical field.

The following examples make it possible to understand more clearly the present application, without limiting the scope thereof.

### Examples

### 1. Measurement Methods

The measurement methods used in the examples are described below.

### Molecular Weights of the Copolymers According to the Invention

They are determined by Size Exclusion Chromatography (SEC).

Such a technique uses a liquid chromatography device of the WATERS™ brand equipped with a detector. This detector is a refractometric concentration detector of the WATERS™ brand.

This liquid chromatography device is equipped with a size exclusion column suitably chosen by the person skilled in the art in order to separate the various molecular weights of the polymers studied.

The liquid elution phase is an aqueous phase adjusted to pH 9.00 using 1N sodium hydroxide containing 0.05M of NaHCO₃, 0.1M of NaNO₃, 0.02M of triethanolamine and 0.03% of NaN₃.

In a detailed manner, according to a first step, the copolymer is diluted to 0.9% dry in the SEC solubilizing solvent, which corresponds to the liquid elution phase of the SEC, to which 0.04% of dimethylformamide is added, the latter acting as a flow marker or internal standard. Filtration is then carried out at 0.2 μm. 100 μL are then injected into the chromatography device (eluent: an aqueous phase adjusted to pH 9.00 using 1N sodium hydroxide containing 0.05 M of NaHCO₃, 0.1M of NaNO₃, 0.02 M of triethanolamine and 0.03% of NaN₃).

The liquid chromatography device contains an isocratic pump (WATERS™ 515), the flow rate of which is adjusted to 0.8 mL/min. The chromatography device also comprises an oven which, itself, comprises, in series, the following column system: a precolumn of GUARD COLUMN ULTRAHYDROGEL WATERS™ type which is 6 cm long and 40 mm in internal diameter and a linear column of ULTRAHYDROGEL WATERS™ type which is 30 cm long and 7.8 mm in internal diameter. The detection system, for its part, is composed of a refractometric detector of RI WATERS™ 410 type. The oven is brought to the temperature of 60° C. and the refractometer is brought to the temperature of 45° C.

The chromatography device is calibrated using powdered sodium polyacrylate standards of different molecular masses that are certified for the supplier: POLYMER STANDARD SERVICE or AMERICAN POLYMER STANDARDS CORPORATION.

### Brookfield Viscosity

The Brookfield viscosity of the aqueous suspensions was measured after one hour of production and after one minute of stirring at 25° C.±1° C. at 100 rpm using a Brookfield viscometer of RVT type equipped with an appropriate disk spindle, for example a 2 to 5 spindle.

### pH Measurement

The pH of a suspension or of a solution was measured at 25° C. using a Mettler Toledo Seven Easy pH meter and a Mettler Toledo InLab® Expert Pro pH electrode. A three-point calibration (according to the segmentation method) of the instrument was carried out first using commercially available buffer solutions (available from Sigma-Aldrich Corp., USA) with a pH of 4, 7 and 10 at 20° C. The pH values given are the final values detected by the instrument (the measurement is terminated when the signal measured differs by less than 0.1 mV from the mean over the last 6 seconds).

### Granulometric Distribution

The granulometric distribution of the PCC particles prepared was measured using a Sedigraph 5100 device from the company Micromeritics, USA. The method and the instrument are known to the person skilled in the art and are commonly used for determining the grain size of mineral fillers and pigments. The measurement was carried out in an aqueous solution comprising 0.1% by weight of Na₄P₂O₇. The samples were dispersed using a high-speed stirrer and ultrasound. No other dispersing agent was added for the measurement of the dispersed samples.

### Dry Solids Content of an Aqueous Suspension

The dry solids content of the suspension (also known as “dry weight”) was determined using an MJ33 moisture analyzer from Mettler-Toledo, Switzerland, with the following settings: drying temperature of 160° C., automatic halting if the mass does not vary by more than 1 mg over a period of 30 seconds, standard drying of 5 g to 20 g of suspension.

### Specific Surface Area (SSA)

The specific surface area was measured using the BET method in accordance with the ISO 9277 standard using nitrogen, followed by conditioning of the sample by heating at 250° C. for a period of 30 minutes. Before carrying out these measurements, the sample is filtered on a Büchner funnel, rinsed with deionized water and dried overnight in an oven at a temperature of between 90° C. and 100° C. Subsequently, the dry filtration cake is thorougly ground in a mortar and the resulting powder is placed in a moisture analysis balance at 130° C. until a constant weight is obtained.

### Specific Carbonation Time

The monitoring of the conductivity, which slowly decreases during the carbonation reaction and then rapidly decreases to reach a minimum value, therefore indicating that the reaction is complete, was used to determine the time necessary to make possible complete precipitation. The specific carbonation time (min/kg of Ca(OH)₂) was determined by the following formula:

$$Specific carbonation time = \frac{{10}^{5} \cdot Tf}{W . {DSC}_{LM}}$$

in which:
Tf (min) is the time necessary to complete the carbonation of the lime milk, as determined by monitoring the conductivity,
W (g) is the weight of the lime milk introduced into the carbonation reactor and
DSC_{LM} (%) is the dry solids content by weight of the lime milk.

### Measurement of the Charge—Mütek

The measurement of the charge was carried out using a Mütek PCD 03 device equipped with a Mütek PCD titrator.

0.5 g to 1 g of dry PCC is weighed in the plastic measuring cell and diluted with 20 mL of deionized water. The displacement piston is put in the “on” position. While the piston oscillates in the cell, there is a wait for the flow current between the two electrodes to stabilize.

The sign of the measured value displayed on the screen indicates whether the charge of the sample is positive (cationic) or negative (anionic). A polyelectrolyte of opposite charge with a known charge density is added to the sample as titrating agent (either 0.001 N sodium polyoxyethylene sulfate or 0.001 N pDADMAC). The charges of the titrating agent neutralize the existing charges of the sample. The titration is interrupted as soon as the point of zero charge (0 mV) is reached.

The consumption of the titrating agent in mL is used as a basis for the subsequent calculations. The amount of specific charge q [eq/g of suspension] is calculated according to the following formula:

a=(V*c)/w

V: volume of titrating agent consumed [L]
c: concentration of the titrating agent [eq/L] or [μeq/L]
w: weight of the weighed suspension [g]
a: amount of specific charge [eq/g of suspension] or [μeq/g of suspension]

### Zeta Potential

In order to measure the Zeta potential, a few drops of PCC suspension are dispersed in a sufficient amount of serum obtained by mechanical filtration of said suspension in order to obtain a slightly cloudy colloidal suspension.

This suspension is introduced into the measuring cell of the Zetasizer Nano-ZS device from Malvern which directly displays the value of the Zeta potential of the PCC suspension in mV.

### 2. Preparation of Precipitated Calcium Carbonate (PCC)

A lime milk was prepared by mixing, with mechanical stirring, water and different polymer additives, optionally in the presence of a slaking additive (for example dry sodium citrate, NaCi), at an initial temperature of between 40° C. and 41° C. (the amounts of polymer additives and optionally of slaking additives are indicated in table 1 below). Subsequently, the calcium oxide (quicklime raw material from Golling, Austria) was added with stirring. The mixture obtained was stirred for 25 min and then sieved through a 200 μm sieve.

The lime milk obtained was transferred into a stainless steel reactor, in which the lime milk was cooled to 50° C. The lime milk was then carbonated by introducing an air/CO₂ mixture (26 vol. % of CO₂ and a flow rate of 23 L/min). During the carbonation step, the reaction mixture was stirred at a speed of 1,400 rpm. The kinetics of the reaction were monitored by inline pH and conductivity measurements.

### Exemplified Polymer Additives:

P1=copolymer of styrene and of maleic anhydride (S:MA molar ratio=1:1) of molecular weight 5000 g/mol and neutralized with NaOH to pH=10 (solids content 30% by weight), according to the invention, of formula (III):

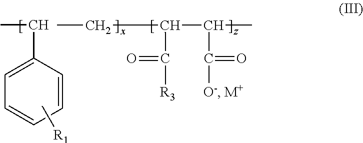

in which:
x and z units are arranged alternately,
x and z are non-zero, the sum of x+z being less than or equal to 150,
R₁ represents H,
R₃ represents (O⁻, M⁺) and
M⁺ represents Na⁺.

P2=sodium polyacrylate (outside the invention)—Mw=4,270 g/mol, PI=2.3 (Mw and PI determined according to the unpublished patent application EP 14166751.9).

TABLE 1
Characteristics of the lime milks

| | | | | | Amount of | |
|---|---|---|---|---|---|---|
| | | | Amount of polymer | | slaking additive | Solids content |
| | | Polymer | additive | Slaking | [% by weight | of the lime milk |
| | | additive | [% by weight CaO] | additive | CaO] | [% by weight] |
| 1 | OINV | none | — | NaCi | 0.1 | 25.2 |
| 2 | OINV | none | — | NaCi | 0.1 | 16.2 |
| 3 | INV | P1 | 0.15 | NaCi | 0.1 | 26.9 |
| 4 | INV | P1 | 0.15 | — | — | 27.1 |
| 5 | OINV | P2 | 0.15 | NaCi | 0.1 | 29.5 |

(INV: according to the INVention-OINV: Outside INVention)

The characteristics of the lime milks and of the PCC aqueous suspensions prepared are described in table 2 below.

TABLE 2
Characteristics of the lime milks and of the PCC aqueous suspensions

| | Viscosity | | Solids | | | | | |
|---|---|---|---|---|---|---|---|---|
| | of the | | content of | Viscosity | | | | |
| | lime milk | Carbonation | S-PCC | of S-PCC | Zeta | | | |
| | (mPa · s) at | time (min/kg | [% by | (mPa · s) at | potential | Mutek | D50 | SSA |
| Tests | 100 rpm | of Ca(OH)₂) | weight] | 100 rpm | (mV) | (μeq/g) | (μm) | (m²/g) |
| 1 OINV | Viscosity of the lime milk excessively high | | | | Not measured | | | |
| 2 OINV | 23 | 44 | 20.5 | 20 | 5.5 | 0.1 | 1.6 | 4.7 |
| 3 INV | 150 | 46 | 35.0 | 199 | −18.1 | −0.5 | 1.5 | 4.2 |
| 4 INV | 101 | 51 | 34.2 | 1,730 | 3.1 | 3.4 | 1.7 | 4.5 |
| 5 OINV | 329 | 47 | 37.6 | 940 | −35.2 | −0.9 | 1.3 | 5.0 |

(INV: according to the INVention-OINV: Outside INVention)

The results recorded in table 2 show that the use of a slaking additive alone results in a lime milk with a high Brookfield viscosity (test 1) and that it is not possible to increase the dry solids content of the lime milk (% by weight) while preventing an increase in the viscosity of the suspension (comparison of test 1 and of test 2).

On the other hand, sample 3 according to the invention confirms that the viscosities of the lime milk and of the PCC suspension obtained are compatible with the anticipated use of the PCC thus obtained, that is to say PCC suspensions with a Brookfield viscosity of less than or equal to 1,500 mPa·s at 25° C., for example less than or equal to 1,000 mPa·s at 25° C. or less than or equal to 600 mPa·s at 25° C., at 100 rpm.

Furthermore, the kinetics of carbonation and the crystallographic structure of the PCC prepared (results not provided) are similar to those obtained with a method involving the use of an anionic polymer (polymer P2 outside the invention, solely by way of comparison).

1. A method for preparing a precipitated calcium carbonate aqueous suspension, the method comprising:
slaking a calcium oxide containing material in water in the presence of at least one copolymer of formula (I) to obtain a lime milk, and
then carbonating the lime milk: 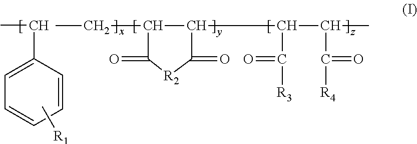
in the formula (I):
x, y and z units are arranged in blocks, randomly, alternately or statistically,
x is non-zero and at least one of y and z is non-zero, x+y+z is less than or equal to 150,
R₁ represents H or a sulfonated group,
R₂ represents a heteroatom, optionally substituted by an alkyl chain, an alkenyl chain, a heteroalkyl chain and/or a polyalkoxylated chain,
R₃ and R₄, independently of one another, represent OH, (O⁻, M⁺), an O-alkyl chain comprising 1 to 20 carbon atoms, a N-alkyl chain comprising 1 to 20 carbon atoms and/or a polyalkoxylated chain, and
M⁺ represents a monovalent, divalent or trivalent cation.

2. The method according to claim 1, wherein the copolymer is represented by formula (II): 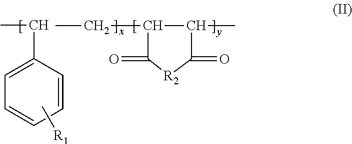
in which:
x and y units are arranged in blocks, randomly, alternately or statistically,
x and y are non-zero, x+y is less than or equal to 150,
R₁ represents H or a sulfonated group, and
R₂ represents a heteroatom, optionally substituted by an alkyl chain, an alkenyl chain, a heteroalkyl chain and/or a polyalkoxylated chain.

3. The method according to claim 1, wherein the copolymer is represented by formula (III): 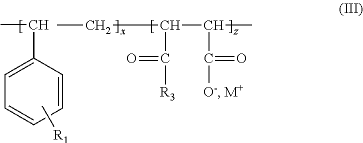
in which:
x and z units are arranged in blocks, randomly, alternately or statistically,
x and z are non-zero, x+z is less than or equal to 150,
R₁ represents H or a sulfonated group,
R₃ represents OH, (O⁻, M⁺), an O-alkyl chain comprising 1 to 20 carbon atoms, a N-alkyl chain comprising 1 to 20 carbon atoms and/or a polyalkoxylated chain, and
M¹ represents a monovalent, divalent or trivalent cation.

4. The method according to claim 1, wherein the calcium oxide containing material and water are mixed in a weight ratio from 1:1 to 1:12.

5. The method according to claim 1, wherein the at least one copolymer is used in combination with at least one slaking additive.

6. The method according to claim 5, wherein the at least one slaking additive is selected from the group consisting of sodium citrate, potassium citrate, calcium citrate, magnesium citrate, a monosaccharide, a disaccharide, a polysaccharide, sucrose, a sugar alcohol, meritol, citric acid, sorbitol, a sodium salt of diethylenetriamine pentaacetic acid, a gluconate, a phosphonate, sodium tartrate, sodium lignosulfonate, and calcium lignosulfonate.

7. The method according to claim 1, wherein the lime milk has a Brookfield viscosity from 1 mPa·s to 1,000 mPa·s at 25° C., at 100 rpm.

8. The method according to claim 1, wherein the precipitated calcium carbonate aqueous suspension has a Brookfield viscosity of less than or equal to 1,000 mPa·s at 25° C., at 100 rpm.

9. The method according to claim 1, wherein the precipitated calcium carbonate aqueous suspension has a dry solids content of at least 10% by weight, based on a total weight of the suspension.
